(19) United States
(12) Patent Application Publication
(10) Pub. No.: US 2025/0139721 A1
(43) Pub. Date: May 1, 2025

(54) ARTIFICIAL INTELLIGENCE AUGMENTED REAL ESTATE PLATFORM

(71) Applicants: Kireet Kokala, Cumming, GA (US); Neil Gulati, San Clemente, CA (US)

(72) Inventors: Kireet Kokala, Cumming, GA (US); Neil Gulati, San Clemente, CA (US)

(21) Appl. No.: 18/496,671

(22) Filed: Oct. 27, 2023

(51) Int. Cl. G06Q 50/16; G06Q 30/0202

(52) U.S. Cl. CPC G06Q 50/16; G06Q 30/0202

(57) ABSTRACT

The present invention introduces an innovative method for real estate valuation through the utilization of an Artificial Intelligence (AI) augmented platform. Traditional real estate sales processes often rely on subjective broker intuition to determine property prices, resulting in potential revenue loss for sellers and delayed commissions for brokers. The disclosed platform incorporates advanced machine learning models and quantitative analysis of real estate data to significantly enhance valuation accuracy. By harnessing specific AI technologies such as unsupervised learning and deep learning, this invention aims to reduce the time properties spend on the market and benefit buyers, sellers, and brokers. This patent application provides a comprehensive description of the novel AI-driven approach developed by Artificial Intelligence Real Estate Exploration (Airex LLC).

### SUMMARY OF THE INVENTION

The objective of this invention is to enhance the real estate valuation process, addressing limitations in the residential, luxury, and commercial property sectors. The invention's core features include comprehensive property data acquisition, neighborhood feature engineering, robust modeling through statistical analysis, historical data utilization, and the selection of high-performing predictive models. Leveraging cloud-based infrastructure, a user-friendly web interface, and a mobile application, the platform offers real-time property price predictions and invaluable insights for real estate professionals. This invention revolutionizes the real estate market by combining AI and data-driven techniques to benefit both buyers and sellers.

### DESCRIPTION OF THE DRAWINGS

FIG. 1. An illustration of the core AI engine in the Airex platform.

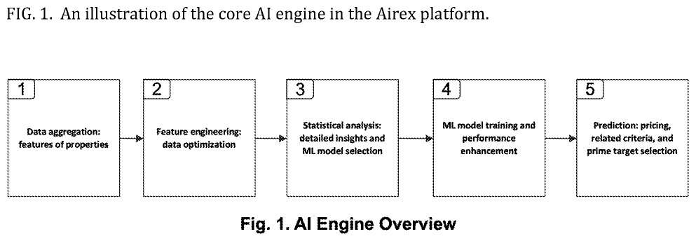

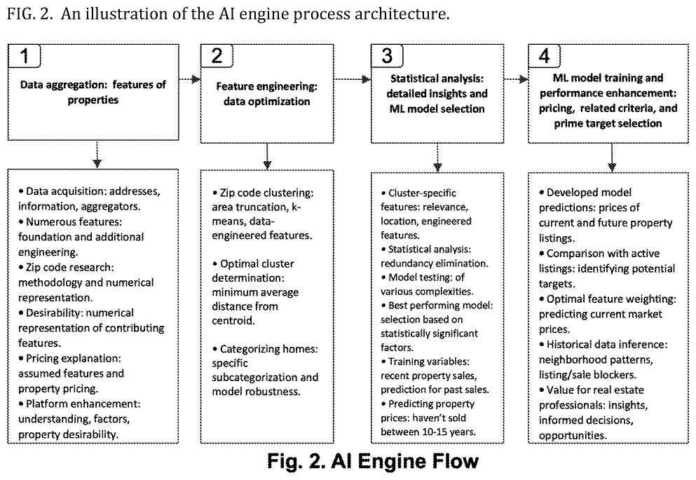

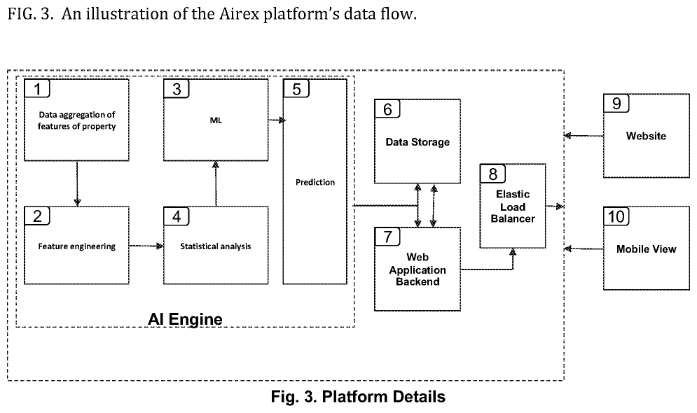

FIG. 1 provides a visual representation of the central AI engine within the Airex platform, showcasing the core components and data flow.
1. Data Acquisition: The process begins with the acquisition of a comprehensive list of property addresses, followed by the retrieval of relevant property data using various methods, including purchase and scraping techniques.
2. Neighborhood Feature Engineering: The platform focuses on optimizing the unique characteristics of each neighborhood. It engineers features that offer a numerical representation of the area's intrinsic value, encompassing factors often overlooked by conventional real estate metrics, such as proximity to the ocean, extent of ocean view, and distance to top-performing schools.
3. Statistical Analysis: A preliminary statistical analysis is conducted to gain insights into the data and identify the most suitable modeling approach. This analysis guides the selection of the model type that will yield the most accurate predictions.
4. Model Training: Historical sales data is employed to train the chosen model, with the most recent data used for cross-validation and testing. This iterative process enhances the model's performance and reliability.
5. Prediction and Comparison: The highest-performing model, determined through rigorous evaluation, is utilized to generate predictions for current properties. These predictions are then compared to active listings, aiding real estate professionals in making informed decisions regarding pricing and market positioning.

FIG. 2. An illustration of the AI engine process architecture.

FIG. 2 provides a detailed illustration of the process architecture of the AI engine within the Airex platform, outlining its crucial components and workflow.
1. Data Acquisition Strategy: The platform initiates the data acquisition process by obtaining a comprehensive list of property addresses and procuring property information from data aggregators. This data serves as the foundation for engineering additional features and improving valuation accuracy.
2. K-Means Clustering: For each zip code area, the first step involves truncating the area through k-means clustering using a data-engineered feature that combines property characteristics. The optimal number of clusters is determined to enhance the categorization of homes into subcategories, increasing model robustness.
3. Predictive Algorithm Selection: Within each cluster of homes, an optimal predictive algorithm is determined through a series of steps, including feature engineering, statistical analysis, and testing of various models such as OLS, LSTM, RNN, and MLP. The goal is to select the best-performing model for each cluster, with training data derived from properties sold in the most recent two years and predictions made for properties sold 10-15 years ago.
4. Model Evaluation: Model selection is based on rigorous evaluation using metrics like Mean Squared Error, Mean Absolute Error, Root Mean Squared Error, and Adjusted R². Computation speed considerations allow for the implementation of complex deep learning models, further enhancing accuracy.

FIG. 3. An illustration of the Airex platform's data flow.

FIG. 3 offers a detailed illustration of the data flow within the Airex platform, demonstrating its dynamic and efficient processes.
1. Database Establishment: The initial step involves establishing a robust database that serves as the foundation for analysis. Queries are dynamically created to calculate features based on available data, and Airex can continuously incorporate new data to enhance model optimization.
2. Preliminary Statistical Analysis: Airex functions and drivers conduct a preliminary statistical analysis, enabling the extraction of queried data and its integration into the algorithm. This phase also includes the selection of the most suitable machine learning model.
3. Real-Time Data Integration: As new data becomes available, predicted values are dynamically incorporated, ensuring real-time adjustments and accurate predictions, which is critical in a dynamic real estate market.
4. Data Persistence: Data is stored efficiently using hyperscaler cloud-based storage solutions, such as Amazon Web Services (AWS) Relational Database Service (RDS) or Google Cloud Platform (GCP), ensuring secure and reliable access for analysis.
5. Efficient Web Application: Airex includes a user-friendly web interface developed using professional JavaScript frameworks. It offers seamless access to predicted values and data analysis, allowing users to apply filters and tailor their experience.
6. Mobile Application: The mobile application mirrors the functionality of the web interface, offering flexibility and convenience for users across different devices. Users can access predictions and platform features with ease.
7. AI Engine Integration: The AI engine, a core component, is hosted on the cloud platform's backend. This integration enables the web application to harness the AI engine's capabilities, providing users with valuable insights and analysis.

8. User Control: A collection of variables is available within the web application, allowing users to customize criteria for listing display and search. This customization ensures a personalized and user-centric experience.

### FIELD OF THE INVENTION

The present invention is situated within the real estate domain, encompassing diverse aspects such as online real estate advertising, automation methods, and systems enabling property tagging by various stakeholders. Its significance extends across a broad spectrum of domains, including but not limited to real estate markets, insurance, home improvement, marketing for properties offered by owners, high-end real estate listings, and commercial facilities. The innovation at hand represents a versatile and impactful solution with applications that resonate in various sectors within the real estate industry and related domains.

1. Virtual Real Estate Platform Creation: This invention presents a method for creating a virtual real estate platform, empowered by an augmented artificial intelligence system. Key elements include:
a. Providing a database housing properties and enriched data factors, encompassing images, pricing criteria, and weighted scoring in comparison to similar properties.
b. Facilitating access to this property information for devices, including mobile platforms, via network connectivity.

2. Comprehensive Data Enrichment: Building upon the virtual real estate platform, this method encapsulates a broad data spectrum. It incorporates granular features typically omitted in conventional real estate predictions.

3. AI-Driven Neighborhood Analysis: Integral to this innovation is the engineering of region-specific features that quantitatively represent the intrinsic value of distinct areas. This approach transforms the understanding of pricing dynamics by leveraging AI-powered insights.

4. Customized Predictive Power: Underpinning the AI engine are custom statistical analyses, enhancing the platform's predictive capabilities. Machine learning models identify optimal opportunities for real estate professionals and refine the selling process.

5. Model Training and Optimization: The method further includes training machine learning models with the Airex platform's extensive data, with a focus on improving pricing accuracy and related criteria. Advanced algorithms identify strong leads and select properties aligning with user needs based on prevailing market conditions.

6. Cloud-Based Infrastructure: The Airex platform is engineered on a public cloud provider, such as AWS or GCP. This choice offers scalability, data storage, machine learning capabilities, and data visualization services.

7. Seamless User Experience: The platform's user-centric approach extends to the development of a web application, boasting functions like user authentication, notification settings, persona customization, property searches, tour sign-ups, and alerts tailored to user-selected criteria.

8. End-to-End Security and Scalability: Airex integrates engineered features that ensure security, scalability, and redundancy throughout the platform, bolstering its reliability.
